(19) United States
(12) Patent Application Publication
(10) Pub. No.: US 2013/0162412 A1
(43) Pub. Date: Jun. 27, 2013

(54) REMOTE CONTROL SYSTEM AND METHOD

(71) Applicants: KUO-CHIH YU, New Taipei (TW); CHIEN-CHUN FU, New Taipei (TW)

(72) Inventors: KUO-CHIH YU, New Taipei (TW); CHIEN-CHUN FU, New Taipei (TW)

(21) Appl. No.: 13/716,218

(22) Filed: Dec. 17, 2012

(30) Foreign Application Priority Data
Dec. 27, 2011 (TW) 100149035

(51) Int. Cl. G08C 17/02

(52) U.S. Cl. CPC G08C 17/02
USPC 340/12.5

(57) ABSTRACT

A remote control system for controlling remotely a plurality of remote controllable appliances includes a first and second mobile terminal, at least one remote control apparatus, a server, and at least one remote control apparatus. The first mobile terminal transmits a first wireless signal in response to a remote controllable appliance selection and a function to be performed to the server. The server transmits a second wireless signal carrying an identification for identifying the selected remote controllable appliance and the selected function to the second mobile terminal. The second mobile terminal transmits a third wireless signal carrying an infrared remote control code correspondingly to the remote control apparatus, thereby the remote control apparatus transmitting an infrared remote control signal carrying the infrared remote control code to the selected remote controllable appliance to execute the selected function.

### BACKGROUND

1. Technical Field

The present disclosure relates to remote controllers and, particularly, to a remote control system and a method capable of controlling devices remotely via a wireless mobile terminal.

2. Description of Related Art

Remote controls are generally employed to remotely control digital appliances within a predetermined area. However, the remote control can only be used to control a pre-designated appliance. Furthermore, the remote control can only control the digital appliance which is in the same room as the remote control. Therefore, if user has a number of appliances, a number of remote controls are needed. A number of remote controls for a number of appliances brings inconvenience for user.

### BRIEF DESCRIPTION OF THE DRAWINGS

The components of the drawings are not necessarily drawn to scale, the emphasis instead being placed upon clearly illustrating the principles of the disclosure. Moreover, in the drawings, like reference numerals designate corresponding parts throughout several views.

FIG. 1 is a schematic diagram of a remote control system in accordance with an exemplary embodiment.

FIG. 2 is a schematic diagram of the remote control system in accordance with another exemplary embodiment.

FIG. 3 is a block diagram of the remote control system of FIG. 1 in accordance with an exemplary embodiment.

FIG. 4 is a schematic diagram showing a using state of selecting appliances on a first mobile terminal of the remote control system of FIG. 1 in accordance with an exemplary embodiment.

FIG. 5 is a schematic diagram showing a using state of providing a remote control interface of a selected appliance on the first mobile terminal of the remote control system of FIG. 1 in accordance with an exemplary embodiment.

FIG. 6 is a structure diagram of a light directing element of the remote control apparatus of the remote control system of FIG. 1 in accordance with an exemplary embodiment.

FIG. 7 is a block diagram of the remote control system of FIG. 2 in accordance with an exemplary embodiment.

FIG. 8 is a flowchart of a method capable of remote controlling appliances in accordance with an exemplary embodiment.

### DETAILED DESCRIPTION

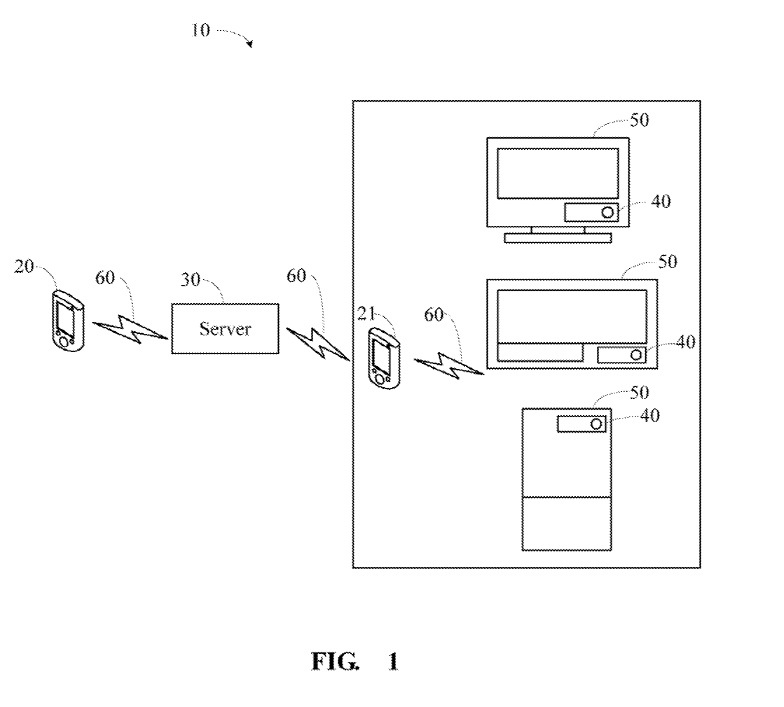

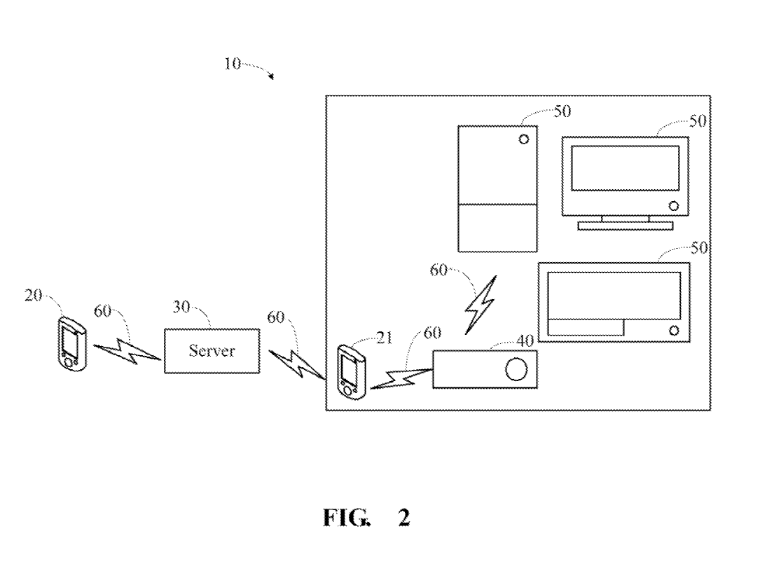

FIGS. 1 and 2 are schematic diagrams showing a remote control system in accordance with two embodiments. The remote control system 10 includes a first mobile terminal 20, a second mobile terminal 21, a server 30, at least one remote control apparatus 40, and at least one appliance 50. The first mobile terminal 20 and the second mobile terminal 21 are devices such as e-books, personal digital assistants (PDAs), mobile phones, or tablet computers, and communicate with the server 30 via network 60, such as WiFi, Bluetooth, or ZigBee, for example. The remote control apparatus 40 communicates with the second mobile terminal 21 via the network 60. In the embodiment, the first mobile terminal 20 and the second mobile terminal 21 are located in different rooms. The first mobile terminal 20 is configured for transmitting a first wireless signal to the server 30 in response to a user's operation. In the embodiment, the server 30 is a cloud server.

In the embodiment, one remote control apparatus 40 corresponds to one appliance 50 and is mounted on or located before one of the at least one appliance 50 and just before an infrared receiving window (not shown) defined in the appliance 50, as shown in FIG. 1. In an alternative embodiment, one remote control apparatus 40 corresponds to a number of appliances 50 as shown in FIG. 2. The remote control apparatus 40 and the appliances 50 are located in the same room.

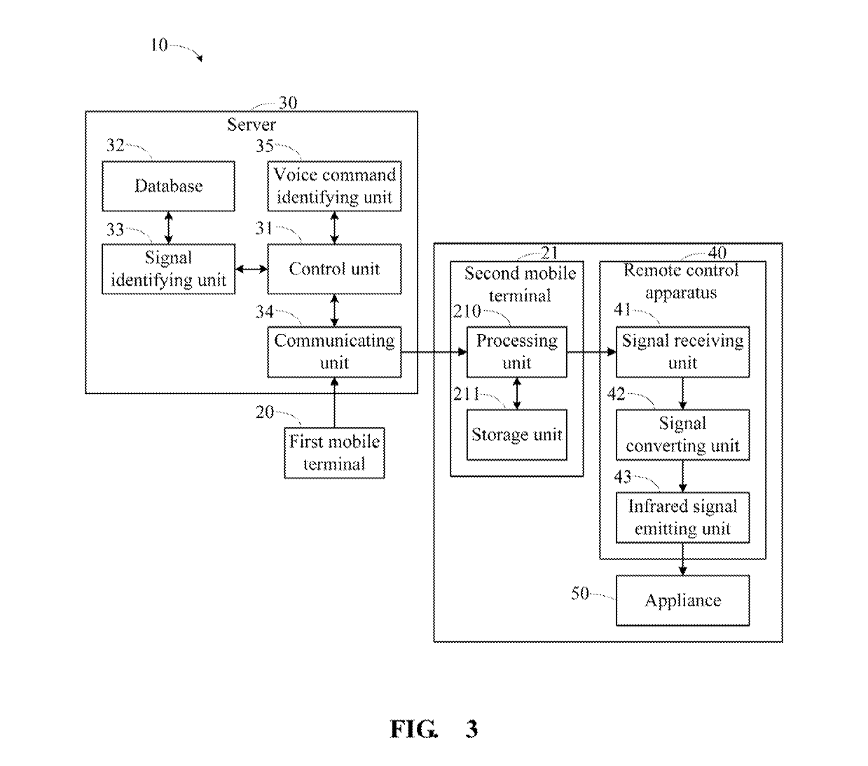

FIG. 3 shows that the server 30 includes a control unit 31, a database 32, a signal identifying unit 33, and a communicating unit 34. The database 32 is configured for storing a first table listing names of the at least one appliance 50 and a second table listing a plurality of executable functions of each of the at least one appliance 50. The first table and the second table can be downloaded to the first mobile terminal 20 and the second mobile terminal 21.

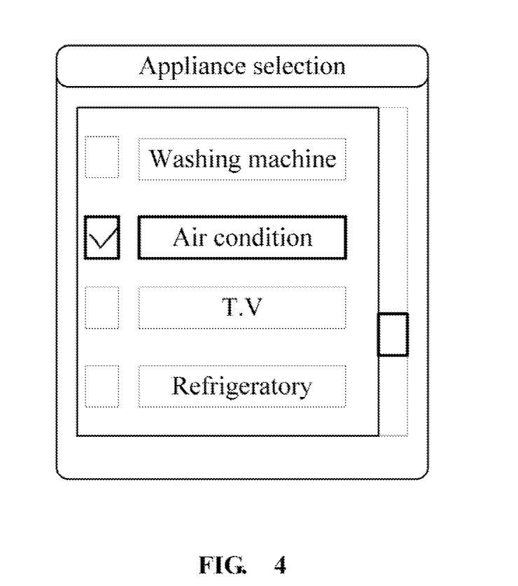

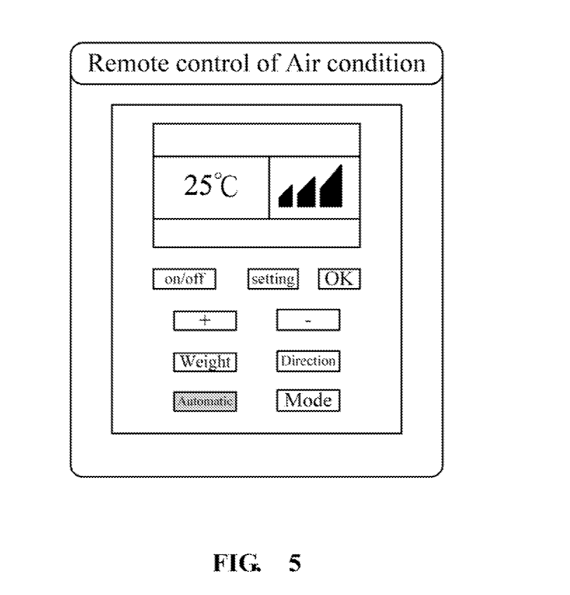

FIGS. 4 and 5 show that if the first table and the second table are downloaded to the first mobile terminal 20, the first mobile terminal runs a particular application to access the first table and the second table stored locally, as well displays a first user interface for showing the names of the at least one appliance 50 recorded in the first table for the user to select an appliance 50, and displays a second interface for the user to select a function of a selected appliance 50. If the first table and the second table are not downloaded to the first mobile terminal 20, the first mobile terminal 20 assesses the server 30 online and obtains the first table stored in the database 32 via the network 60 in response to a remote control operation of a user, and displays the first user interface for showing the names of the at least one appliance 50 recorded in the first table for the user to select an appliance 50. The first mobile terminal 20 further obtains the second table stored in the database 32 via the network 60 in response to an appliance selection operation of the user. The first mobile terminal 20 includes an input unit (not shown), configured for allowing the user to select the appliance 50 and activate a function to be performed on the selected appliance 50. For example, the first mobile terminal 20 displays a first user interface on the input unit displaying the appliance icons representing the respective appliances 50. If the appliance icon “air condition” is selected, the first mobile terminal 20 further displays the second user interface displaying function icons representing functions of the selected appliance icon. When one of the function icons is selected, the first mobile terminal 20 generates a first wireless signal with an identification for identifying the selected appliance 50 and the selected function, and transmits the first wireless signal to the server 30 via the network 60.

The signal identifying unit 33 of the server 30 receives the first wireless signal transmitted from the first mobile terminal 20 via the network 60, determines the selected appliance 50 and the selected function according to the first wireless signal, and generates a second wireless signal carrying the identification for identifying the selected appliance 50 and the selected function. The control unit 31 controls the communicating unit 34 to transmit the second wireless signal to the second mobile terminal 21. In the embodiment, each of the at least one appliance 50 and each executable function of the appliance 50 has been assigned with an unique identification.

In the embodiment, the server 30 further includes a voice command identifying unit 35. The sound identifying unit 35 is configured for identifying a voice command transmitted by the first mobile terminal 20, and determining the selected appliance 50 and the selected function according to the identified voice command, the first table, and the second table.

In an alternative embodiment, the database 32 is further configured for storing a third table listing a relationship between a plurality of user information and a plurality of specific appliances 50, listing authorizations of users to control particular appliances 50, or particular functions of particular appliances. The third table can be preset by the first mobile terminal 20 or the second mobile terminal 21 on the server 30 or uploaded to the server 30 by the first mobile terminal 20 or the second mobile terminal 21. For example, the plurality of specific appliances 50 include a microwave oven, an electric heater, and an induction cooker. The authorized users include three men A, B, and C. The third table records that A and B are authorized to remotely control the microwave oven, the electric heater, and the induction cooker; and C is authorized to remotely control the microwave oven only. The first mobile terminal 20 further displays a third user interface for prompting the user to input a user name and a password in response to the appliance selection of the user on the first user interface. The first mobile terminal 20 transmits the input user name, the password, and the selected appliance 50 to the server 30 via the network 60. The signal identifying unit 33 determines whether the user is authorized to control the selected appliance 50 according to the third table. If the user is authorized to control the selected appliance 50, the control unit 31 controls the communicating unit 34 to transmit the second wireless signal to the second mobile terminal 21. If the user is not authorized to control the selected appliance 50, the control unit 31 controls the communicating unit 34 to transmit a wireless signal refuse message to the first mobile terminal 20 to refuse the user, the refuse message is displayed to the user on the first mobile terminal 20.

The second mobile terminal 21 includes a processing unit 210 and a storage unit 211. The storage unit 211 is configured for storing a fourth table listing mapping relationships among the appliances 50, the functions of each appliance 50, and the infrared remote control codes. When the second mobile terminal 21 receives the second wireless signal transmitted by the server 30, the processing unit 210 determines the infrared remote control code associated with the selected function according to the fourth table, and transmits a third wireless signal carrying the infrared remote control code to the remote control apparatus 40.

The remote control apparatus 40 includes a signal receiving unit 41, a signal converting unit 42, and an infrared signal emitting unit 43. The signal receiving unit 41 receives the third wireless signal transmitted by the second mobile terminal 21. The signal converting unit 42 converts the third wireless signal to an infrared remote control signal carrying the infrared remote control code. The infrared signal emitting unit 43 transmits the infrared remote control signal to the selected appliance 50 to execute the selected function.

In the embodiment, the remote control apparatus 40 further includes a power supply 44, such as a solar battery, mounted on the outside surface of the remote control apparatus 40.

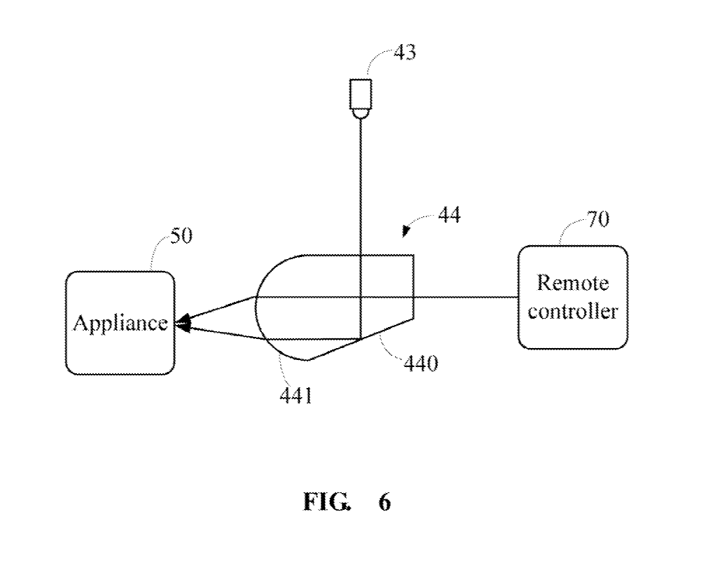

FIG. 6 shows that in the embodiment, the remote control apparatus 40 further includes a light directing element 45. The light directing element 45 includes a reflection part 450 and an emitting part 451. In the embodiment, the reflection part 450 faces the infrared signal emitting unit 43 to reflect and direct the infrared remote control signal transmitted by the infrared signal emitting unit 43, thereby the reflected infrared remote control signal being received by the appliance 50. The remote control apparatus 40 further defines an infrared signal receiving window (not shown) therein facing the emitting part 451. An infrared remote control signal transmitted by a remote controller 70 passes through the infrared signal receiving window and the emitting part 451 orderly and finally is received by the appliance 50.

In an alternative embodiment, the reflection part 450 faces the infrared signal receiving window to reflect and direct the infrared signal from a remote control 70, thereby the reflected infrared remote control signal being received by the appliance 50. The emitting part 451 faces the infrared signal emitting unit 43 to allow the infrared remote control signal transmitted by the infrared signal emitting unit 43 to pass through the light directing element 45, thereby the emitted infrared remote control signal being received by the appliance 50.

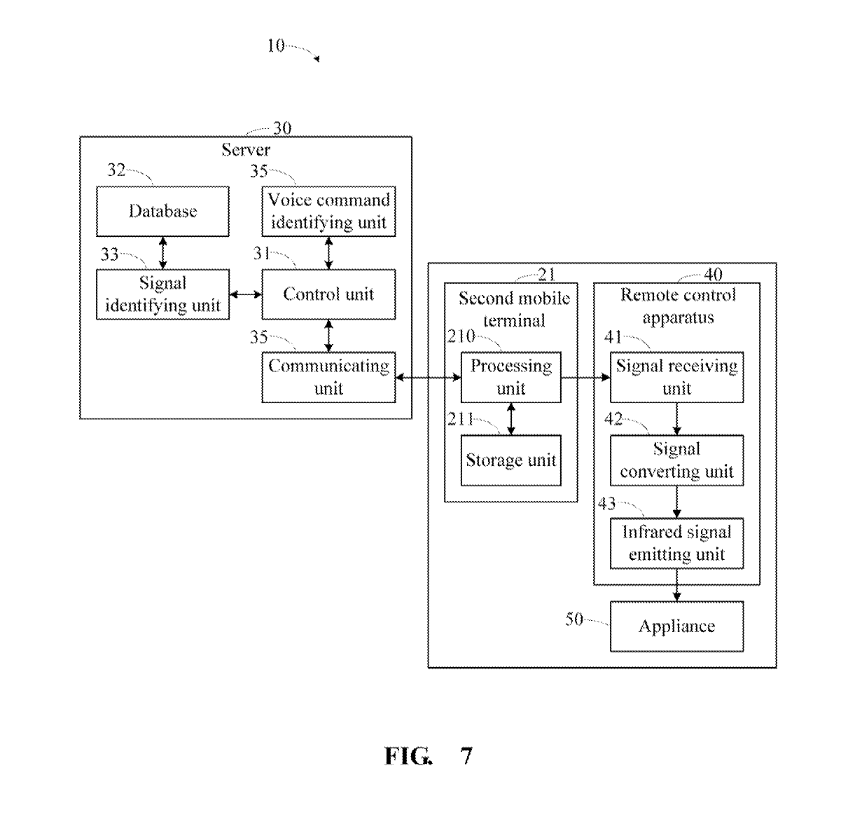

FIG. 7 shows that in an alternative embodiment, the second mobile terminal 21 is located in the same room where the appliances 50 are located in. The second mobile terminal 21 obtains the first table and the second table from the server 30 in response to the appliance selection and the function selection of the user, and transmits a wireless signal correspondingly to the server 30. The signal identifying unit 33 determines the selected appliance 50 and the selected function according to the wireless signal. The control unit 31 controls the communicating unit 34 to transmit the second wireless signal to the second mobile terminal 21. The processing unit 210 determines the infrared remote control code according to the second wireless signal and the fourth table, and transmits the wireless signal carrying the infrared remote control code to the remote control apparatus 40. The remote control apparatus 40 transmits the infrared remote control signal carrying the remote control code to the selected appliance 50 to execute the selected function.

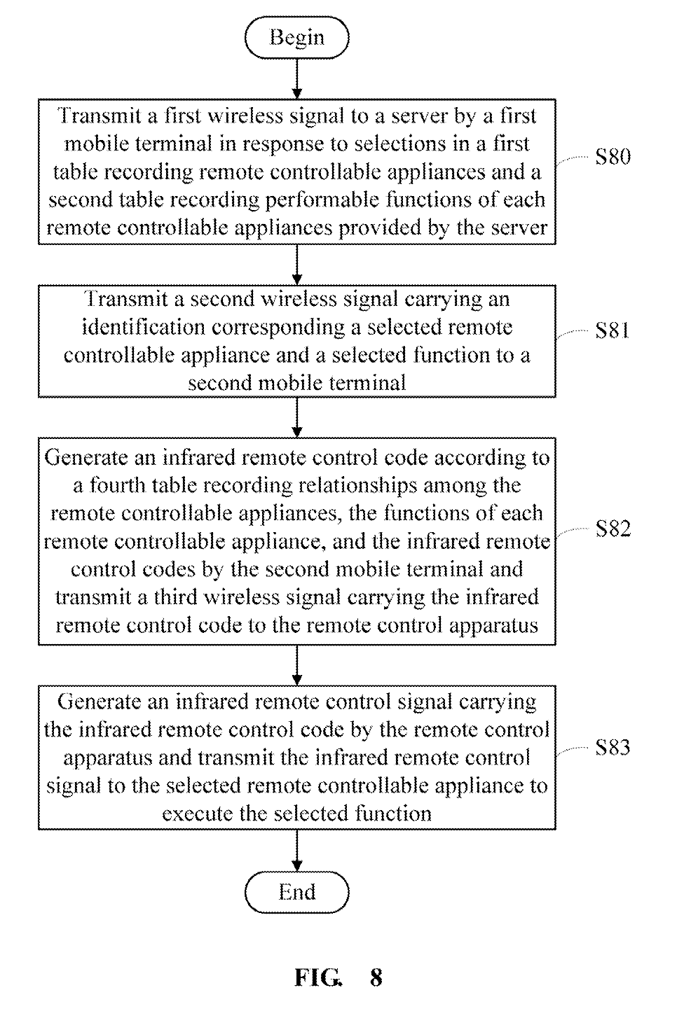

FIG. 8 illustrates a method capable of remote control operation.

In step S80, the first mobile terminal 20 obtains the first table and the second table stored in the database 32 via the network 60 in response to a remote control operation of a user, displays the second table for user to select a function to be performed when one appliance 50 recorded in the first table is selected by the user, generates the first wireless signal with the identification for identifying the selected appliance 50 and the selected function, and transmits the first wireless signal to the server 30 via the network 60.

The first table records names of the at least one appliance 50. The second table records a plurality of executable functions of each of the at least one appliance 50.

In step S81, the signal identifying unit 33 receives the first wireless signal transmitted from the first mobile terminal 20 via the network 60, determines the selected appliance 50 and the selected function according to the first wireless signal, and generates the second wireless signal carrying the identification for identifying the selected appliance 50 and the selected function. The control unit 31 controls the communicating unit 34 to transmit the second wireless signal to the second mobile terminal 21.

In an alternative embodiment, the database 32 stores the third table listing a relationship between a plurality of user information and a plurality of specific appliances 50, listing authorizations of users to control particular appliances, or particular functions of particular appliances. The third table can be preset by the first mobile terminal 20 or the second mobile terminal 21 on the server 30 or uploaded to the server 30 by the first mobile terminal 20 or the second mobile terminal 21. For example, the plurality of specific appliances 50 include a microwave oven, an electric heater, and an induction cooker. The authorized users include three men A, B, and C. The third table records that A and B are authorized to remotely control the microwave oven, the electric heater, and the induction cooker; and C is authorized to remotely control the microwave oven only. The first mobile terminal 20 further displays a third user interface for prompting the user to input a user name and a password in response to the appliance selection of the user on the first user interface. The first mobile terminal 20 transmits the input user name, the password, and the selected appliance 50 to the server 30 via the network 60. The signal identifying unit 33 determines whether the user is authorized to control the selected appliance 50 according to the third table. If the user is authorized to control the selected appliance 50, the control unit 31 controls the communicating unit 34 to transmit the second wireless signal to the second mobile terminal 21. If the user is not authorized to control the selected appliance 50, the control unit 31 controls the communicating unit 34 to transmit a wireless refuse message to the first mobile terminal 20 to refuse the user, the refuse message is displayed to the user on the first mobile terminal 20.

In step S82, the processing unit 210 determines the infrared remote control code associated with the selected function according to the fourth table, and transmits the third wireless signal carrying the infrared remote control code to the remote control apparatus 40.

In step S83, The signal receiving unit 41 receives the third wireless signal transmitted by the second mobile terminal 21. The signal converting unit 42 converts the third wireless signal to an infrared remote control signal carrying the infrared remote control code. The infrared signal emitting unit 43 transmits the infrared remote control signal to the selected appliance 50 to execute the selected function.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A remote control system for remotely controlling a plurality of remote controllable appliances, comprising:
a first mobile terminal configured for transmitting a first wireless signal in response to a remote controllable appliance selection made by a user and a function selected by the user to be performed on the selected remote controllable appliance;
a second mobile terminal;
at least one remote control apparatus communicating with the second mobile terminal via a network;
a server communicating with the first mobile terminal and the second mobile terminal via the network, the server comprising:
a database configured for storing a first table listing the plurality of remote controllable appliances and a second table listing a plurality of performable functions of each of the plurality of remote controllable appliances;
a communicating unit configured for receiving the first wireless signal transmitted by the first mobile terminal; and
a signal identifying unit configured for determining the selected remote controllable appliance and the selected function according to the first wireless signal, generating a second wireless signal carrying an identification for identifying the selected remote controllable appliance and the selected function, and transmitting the second wireless signal to the second mobile terminal via the communicating unit, causing the second mobile terminal to transmit a third wireless signal carrying an infrared remote control code corresponding to the selected remote controllable appliance and the selected function to the remote control apparatus, thereby the remote control apparatus transmitting an infrared remote control signal carrying the infrared remote control code to the selected remote controllable appliance to execute the selected function.

2. The remote control system as recited in claim 1, wherein the server is a cloud server.

3. The remote control system as recited in claim 1, wherein the server further comprises:
a voice command identifying unit configured for identifying a voice command transmitted by the first mobile terminal, and determining the selected remote controllable appliance and the selected function according to the identified voice command, the first table, and the second table.

4. The remote control system as recited in claim 1, wherein the database is further configured for storing a third table listing a relationship between a plurality of users and the remote controllable appliances authorized to be controlled by the corresponding users, the signal identifying unit determines whether a user is authorized to control the selected remote controllable appliance according to the third table, and transmits the second wireless signal to the second mobile terminal via the communicating unit if the user is authorized to control the selected remote controllable appliance.

5. The remote control system as recited in claim 4, wherein the signal identifying unit transmits the a wireless refuse message to the first mobile terminal to via the communicating unit, the refuse message is configured to be displayed to the user on the first mobile terminal, if the user is not authorized to control the selected remote controllable appliance.

6. The remote control system as recited in claim 1, wherein the number of the at least one remote control apparatus is equal to the number of the plurality of remote controllable appliances, each of the remote control apparatus is mounted on the corresponding remote controllable appliance.

7. The remote control system as recited in claim 1, wherein the number of the at least one remote control apparatus is one.

8. A method capable of remotely controlling a plurality of remote controllable appliances employed in a remote control system, wherein the remote control system comprising a server, a first mobile terminal, a second mobile terminal, and at least one remote control apparatus, the server storing a first table listing the plurality of remote controllable appliances and a second table listing a plurality of performable functions of each of the plurality of remote controllable appliances, the method comprising:
generating a first wireless signal with an identification for identifying a selected remote controllable appliance and a selected function to be performed on the selected remote controllable appliance using the first mobile terminal according to the first table and the second table in response to a user's input operation, the input operation including selecting the remote controllable appliance and selecting the function to be performed on the selected remote controllable appliance;
determining the selected remote controllable appliance and the selected function according to the first wireless signal using the server;
transmitting a second wireless signal carrying the identification for identifying the selected remote controllable appliance and the selected function from the server to the second mobile terminal;
determining an infrared remote control code associated with the selected remote controllable appliance and the selected function according to a fourth table stored on the second mobile terminal, and transmitting a third wireless signal carrying the infrared remote control code to the remote control apparatus, wherein the fourth table records mapping relationships among the remote controllable appliances, the functions of each remote controllable appliance, and the infrared remote control codes; and
generating an infrared remote control signal carrying the infrared remote control code using the remote control apparatus, and transmitting the infrared remote control signal from the sever to the selected remote controllable appliance to execute the selected function.

9. The method as recited in claim 8, further comprising:
determining whether a user is authorized to control the selected remote controllable appliance at the server, according to user information of the user transmitted by the first mobile terminal and a third table listing a relationship between user information of a plurality of users and a plurality of specific remote controllable appliances, and transmitting the second wireless signal to the second mobile terminal if the user is authorized to control the selected remote controllable appliance.

10. The method as recited in claim 9, further comprising:
transmitting a wireless refuse message to the first mobile terminal, the refuse message configured to be displayed to the user on the first mobile terminal, if the user is not authorized to control the selected remote controllable appliance.
